(19) United States
(12) Patent Application Publication
(10) Pub. No.: US 2026/0149473 A1
(43) Pub. Date: May 28, 2026

(54) INPUT STAGE GAIN CONTROL WITH VARIABLE ATTENUATION PATH

(71) Applicant: MACOM Technology Solutions Holdings, Inc., Lowell, MA (US)

(72) Inventors: Biagio BISANTI, Sophia (FR); Jonathan UGOLINI, Sophia (FR); Sebastien JACQUET, Sophia (FR)

(21) Appl. No.: 19/369,903

(22) Filed: Oct. 27, 2025

Related U.S. Application Data
(60) Provisional application No. 63/724,231, filed on Nov. 22, 2024.

(51) Int. Cl. H04B 1/04

(52) U.S. Cl. CPC H04B 1/04; H04B 2001/0408

(57) ABSTRACT

An amplifier receives and amplifies a received signal having a power range that is greater than the amplifier's linear operating region. The amplifier has a sensing circuit that senses the power of the received signal and, responsive to the input signal power level, generates an impedance control value proportional to the input signal power level. A main signal path amplifies a main path signal portion to generate an amplified signal. An attenuation signal path has a variable impedance controlled by the impedance control value. As the received signal power level increases, the impedance control value reduces the variable impedance, thereby diverting a portion of the received signal away from the main signal path and into the attenuation signal path, and when the received signal power level decreases, a smaller portion of the received signal flows through the attenuation signal path. The variable impedance may have an attenuation signal path transistor.

### RELATED APPLICATION DATA

This application claims the benefit of and, under 35 U.S.C. § 119(e), priority to U.S. Provisional Patent Application No. 63/724,231, filed Nov. 22, 2024, entitled “INPUT STAGE GAIN CONTROL WITH VARIABLE ATTENUATION PATH,” which is incorporated herein by reference in its entirety.

### FIELD

One exemplary aspect relates to amplifiers, and in particular to an amplifier capable of receiving an input signal with a power level dynamic range greater than the linear operating region of the amplifier.

### BACKGROUND

In electronic systems, signals are transmitted between processing systems. These systems may be on the same integrated circuit board, same server room, or separated by great distances. These signals may travel over a fiber optic cable, electrically conductive channel (wireline), or over the air in wireless environments. The distances these signals travel vary by system, as does the environment through which these signals pass from a transmitter to a receiver. As a result, the power level of a signal received at a transmitter can vary from system to system and even over time depending on a variety of factors, including but not limited to transmit power, type of channel, channel length, and environment of use. Receipt of an incoming signal, which has a power dynamic range that varies between a low-power level and a high-power level, creates challenges for the circuitry that receives the signal over the channel.

FIG. 1 illustrates an exemplary prior art amplifier circuit configured to receive a signal over a channel. This example receiver circuit is a common base input stage amplifier. As shown, an input node 104 receives the incoming signal with a power level Pin that can vary in magnitude. The input node 104 connects to an emitter terminal of a transistor 108 and to a current source 112 that biases the transistor. The base terminal of the transistor 108 connects to a Vdc, which is tied to ground, due to the common base design. The collector terminal of the transistor 108 connects to an output node 128 and a resistor Rload 120. The opposing terminal of the resistor Rload 120 connects to Vdc 124, as shown, which in this embodiment is 1.7 volts.

During operation, an incoming signal is presented to the input node 104 and is amplified through the transistor 108 to create an amplified signal. The amplified signal is presented on the output node 128 as an amplified signal. The biasing is set by the current source 112, and determined based on the biasing needs for the gain level and input signal power.

For low distortion, which is preferred, the transistor 108 must be biased so the output signal swing does not drive the transistor into a region of nonlinear operation, or maximize linearity over input signal power. For a bipolar junction transistor amplifier, this requirement means that the transistor should stay in active mode, and avoid cut-off or saturation. The same requirement applies to a MOSFET amplifier, although the terminology differs—the MOSFET should stay in the active mode, and avoid cutoff or ohmic operation.

The receiver circuit has to handle the input signal power level dynamic, which is a variable signal input power. When the input signal is at a low power level, referred to as the sensitivity level of the receiver's input, the referred noise limits the system's performance. This is often referred to as the signal-to-noise ratio for low-power input signal. When the input signal level increases, the linearity of the receiver circuit limits the performance, such as when a high-power level input signal saturates the transistor.

Several solutions have been proposed to address the challenges of an input signal that varies in power over time and the received signal power swing is greater than the active range of the amplifier. One proposed solution is to maintain linearity for received signals at the high end of the input signal range is to adapt the bias point of the circuit to the increased input signal power level. However, this suffers from the drawback of increased current consumption and reduces the gain.

In addition, if the operating point of the receiver system is adjusted, then the receiver is going to consume more power when receiving a stronger as well as a smaller magnitude signal. There are other issues as well. Changing operating point, such as the gain of the stage, may also require a VGA (variable gain amplifier) after the receiver to avoid saturating the rest of the signal chain. This at least adds additional cost, increases power consumption, and consumes additional space.

Another proposed solution is to place an attenuating circuit or network in front of the receiver. This will desirably attenuate the signals on the high end of the power range, but, to some degree, even a variable attenuator set to its lowest attenuation level will attenuate a low power level signal. Thus, an attenuator will have an assertion loss, even if the attenuation is set at its lowest level. This reduces the signal-to-noise ratio. One drawback to this approach is that the low-power signal should not be attenuated, which will occur even with a variable attenuator.

### SUMMARY

To at least overcome the drawbacks of the prior art and provide additional benefits, a method for amplifying a received signal, which can vary over a power range from a low power to a high power is provided. In one embodiment, this method includes receiving a received signal at a receiver input and sensing a received signal magnitude based on the received signal. Then, the received signal is presented to a main amplifier path and an attenuation path wherein a main path signal portion of the received signal and an attenuation path signal portion of the received signal is determined by the received signal magnitude. This method also includes generating a control signal proportional to the received signal magnitude. Responsive to the control signal, adjusting an impedance of the attenuation path such that an increase in received signal magnitude results in a reduction in the impedance of the attenuation path and a corresponding increase in the attenuation path signal portion, thereby reducing the main path signal portion. This maintains the operation of the amplifier in a linear operating region when receiving a high power received signal.

In one embodiment, the received signal is one of the following: an optic signal, a wireless signal, and/or an electrical signal. The step of sensing a received signal magnitude is performed by a regulator and a sensing circuit that includes a comparator and two or more field effect transistors. The step of sensing the received signal magnitude may also or alternatively comprise sensing a photodetector bias signal. In one configuration, adjusting the impedance of the attenuation paths occurs by the control signal changing a voltage presented to a base terminal of a transistor in the attenuation path. The method described above may further comprise responsive to the received signal being in the bottom 10% of the power range for the received signal, establishing the impedance of the attenuation path high to direct all of the received signal to the main amplifier path.

Also disclosed is an amplifier configured to receive and amplify a received signal with a power range greater than the amplifier's linear operating region. In one configuration, the amplifier (with associated circuitry) comprises an input configured to receive the signal to be amplified and a sensing circuit. The sensing circuit is configured to sense the power of the received signal directly or through monitoring another signal to determine an input signal power level and responsive to the input signal power level, generate an impedance control value that is proportional to the input signal power level. Also part of the amplifier is a main signal path connected to the input and configured to amplify a main path signal portion to generate an amplified signal. In addition, an attenuation signal path connects to the input and has a variable impedance. The impedance of the variable impedance controlled by the impedance control value, wherein as the input signal power level increases, the impedance control value reduces the variable impedance, thereby diverting a larger portion of the input signal away from the main signal path and through the attenuation signal path. As the input signal power level decreases, the impedance control value increases the variable impedance thereby diverting a smaller portion of the input signal through the attenuation signal path.

In one configuration, the signal originated as an optic signal, a wireless signal, or an electrical signal. It is contemplated that the sensing circuit may be a regulator that generates a bias signal and a sensing circuit to determine the value of the bias signal. In addition, the variable impedance comprises an attenuation signal path transistor and the impedance control value sets a base voltage for the attenuation signal path transistor. When the received signal is an optic signal, the amplifier may be a transimpedance amplifier, and a photodetector converts the optic signal to an electrical signal.

The configuration can further include a bias current source configured to provide a main signal path bias current to the main signal path and an attenuation signal path bias current to the attenuation signal path, wherein the bias current source is controlled by a bias current control signal that is proportional to a reference voltage.

In another embodiment, an amplifier is disclosed that is configured as part of a receiver to receive and amplify a received signal having a power range that is greater than the amplifier's linear operating region. This amplifier comprises a main signal path that has an amplifier configured to amplify a received signal or a portion of the received signal. Also part of this embodiment is an attenuation signal path comprising an impedance control device that has an impedance controlled by an impedance control signal. The impedance of the impedance control device determines how much of the received signal flows through the attenuation signal path. In addition, an impedance control signal generator is configured to generate the impedance control signal based on the power level of the received signal.

In one embodiment, the variable impedance comprises an attenuation signal path transistor, and the impedance control value sets a base voltage for the attenuation signal path transistor. When the received signal is an optic signal, the amplifier can be a transimpedance amplifier, and a photodetector converts an optic signal to the received signal. In one configuration, the amplifier further comprises a bias current source configured to provide a main signal path bias current to the main signal path and an attenuation signal path bias current to the attenuation signal path. In such a configuration, the bias current source is controlled by a bias current control signal proportional to a reference voltage. A sensing circuit may also be part of the receiver system, and it can be configured to sense the level power of the received signal directly or by monitoring of another signal in the receiver to determine the power level of the received signal.

In the disclosed receiver system and amplifier, as the input signal power level of the received signal increases, the impedance control value reduces the variable impedance, thereby diverting a larger portion of the received signal away from the main signal path and into the attenuation signal path. And as the power level of the received signal decreases, the impedance control value increases the variable impedance thereby diverting a smaller portion of the received signal through the attenuation signal path. In one embodiment, the impedance control signal is a current that generates a base voltage for an attenuation path transistor.

Other systems, methods, features and advantages of the disclosed technology will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an exemplary prior art amplifier circuit configured to receive a signal over a channel.

FIG. 2 illustrates an example embodiment of a receiver circuit with an auxiliary shunt (attenuation) path.

FIG. 3 illustrates an alternative embodiment of the circuit shown in FIG. 2.

FIG. 4 illustrates an example embodiment of the regulator with a sensing capability.

### DETAILED DESCRIPTION

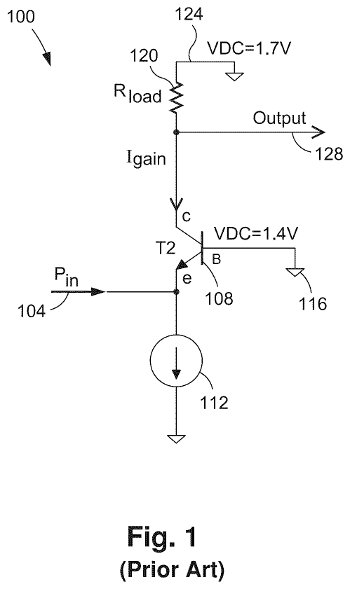

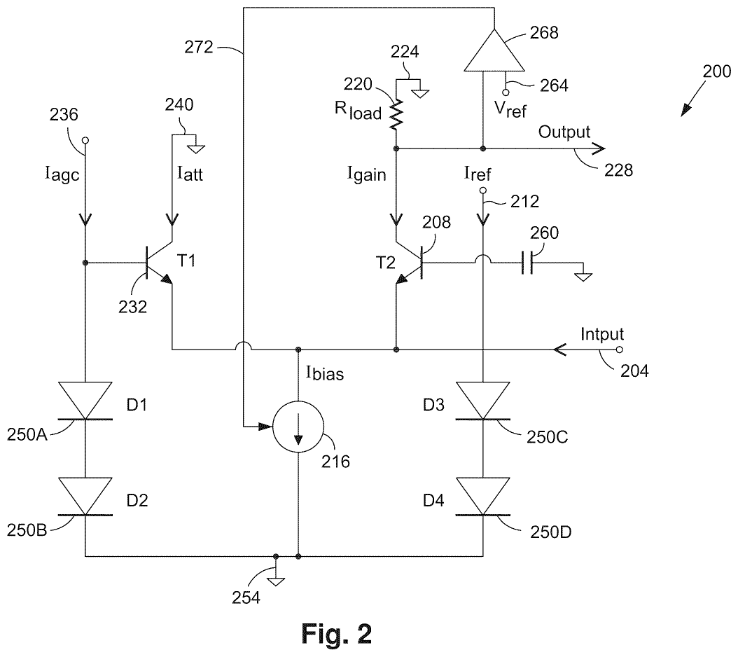

To at least overcome the drawbacks of the prior art and provide additional benefits, disclosed is a circuit for reducing input power to the primary receiver circuit signal path by shunting a portion of the input signal to an auxiliary signal path, also referred to as an attenuation path. FIG. 2 illustrates an example embodiment of a receiver circuit with an auxiliary shunt path. The purpose of the circuit is to attenuate the input signal when the input power increases by enabling a parallel path with a controlled impedance. As shown in FIG. 2, the primary path receiver amplifier is shown by the input node 204, an amplifier transistor T2 208, a bias current source 216, the resistor Rload 220 connected to the supply voltage 224, and the output node 228 as shown. Rload sets the output voltage. This structure is similar to that shown in FIG. 1 and discussed above. In addition to FIG. 1, a capacitor 260 connects to the base terminal of the transistor 208 and to a ground node.

Shown in FIG. 2 is an auxiliary path that runs through a transistor T1 232 such that transistor T1 has an emitter terminal that connects to the input node 204 and the bias current source 216. The transistor T1 232 has a collector terminal that connects to ground node 240 that allows an attenuation current Iatt to flow through transistor T1. A base terminal of transistor T1 232 connects to a control current node 236 such that a control current Iagc flows through node 236 to the diodes 250A, 250B. This creates an impedance control voltage at the base terminal of T1 232 that is determined by the value of Iagc. The diodes 250A, 250B create a translinear circuit and function to establish a voltage drop to create the base voltage for T1 232.

In this configuration, the value of Iagc is proportional to the value of the input signal such that as the input signal becomes larger in magnitude so too does the value of lage, which in-turn increases the value of the base voltage for T1 232. As a result, the impedance of T1 232 changes, thereby allowing a greater portion of the input signal from node 204 to flow through T1.

Also included in the embodiment of FIG. 2 is a reference current Iref that flows through node 212 to the diodes 250C, 250D. The reference current Iref does not change with the input signal. The difference between the base voltage at transistor T1 232 and transistor T2 208 will depend on the value of the Iagc compared to the Iref. In this embodiment, Rload 220 sets the output voltage. In one embodiment, Iref is from a current source that is inside the system. This current source is configured to generate a current that may be proportional to temperature, or Iref may be constant over temperature.

A sensing circuit is also provided that includes a comparator 268 (such as an operational amplifier) that receives the output signal from the output node 228 and a reference voltage Vref on comparator input 264. The output of the comparator 268 comprises a difference between the output signal and the voltage Vref, and this output functions as a bias control signal. As shown, the output of the comparator 268 is routed to the bias current source 216 to control the bias current Ibias. A ground node 254 connects to the bias current source 216.

During operation, the input signal is provided on the input node 204 and presented to transistors T2 208 and T1 232. Transistor T2 208 is biased with Igain while T1 232 is biased with Iatt, both of which are sourced from the current source Ibias 216. Thus, the input signal from the input node 204 will find two paths in parallel. One path is through T2, the primary path, and the other through T1, the auxiliary (attenuation) path. The amount of current through T1 232 reduces the current through T2 208 by shunting a portion of the input signal away from the primary path through T2. In one embodiment, the education in current through T2 208 is half the input signal, so assuming bias point of T1 and T2 are the same, the input current is split in two, resulting in 6 db of attenuation of the input signal. In other embodiments, other levels of attenuation are contemplated.

During operation, the input power may change. Over the range of input signal power levels, transistors T1 208 and T2 232 are not biased the same. At lower input power levels (sensitivity level), the auxiliary path circuit is disabled (not active such that T1 is off with zero base voltage) which results in no impact on the input referred noise and no insertion loss as can be experienced using an attenuator. All of the input signal passes through transistor T2 208, which is the primary path.

The change in the bias through the auxiliary path is controlled by the base voltage presented to the base of T1 232. The base voltage of T1 232 is controlled by the value of the Iagc current through oath 236. Thus, as the input signal increases, so too does the Iagc current, which in turn increases the voltage at the base terminal of transistor T1 232. The increase in base voltage at the base of transistor T1 232 increases the current flow through T1, namely the attenuation current Iatt. This shunts or directs a portion of the input signal away from T2, preventing the unwanted effects of an excessive quantity/amount of an input signal being presented to the input 204 of the amplifier 200.

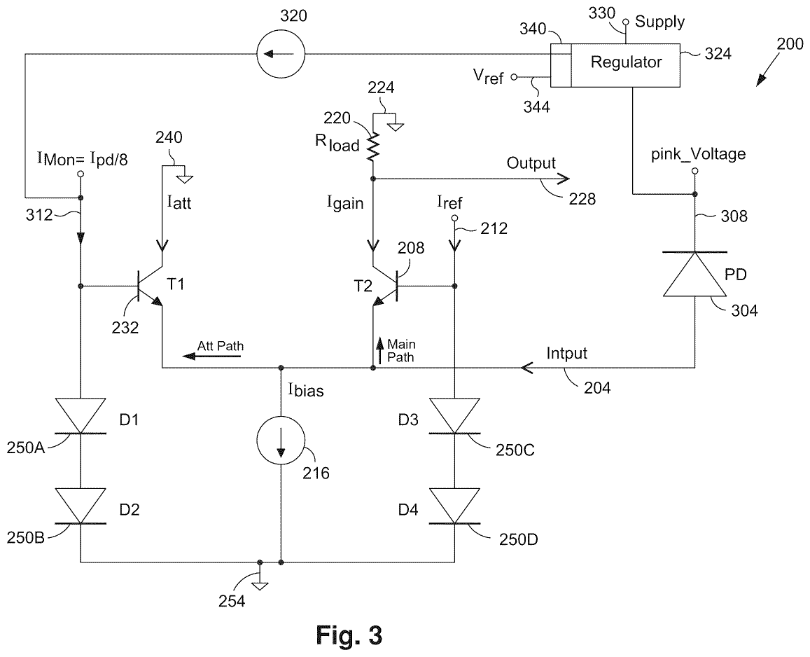

The bias current Ibias is controlled by the average voltage on the Rload, which is a function of the output signal at node 228. The sensing circuit compares the output voltage to the reference voltage to control the Ibias value. This is discussed in connection with FIG. 3. The reference voltage is set by the manufacturer or customer based on the other parameters of the circuit and environment of use. The circuit of FIG. 2 maintains the Rload voltage constant, as determined by the reference voltage presented to node 264.

As discussed above, increasing Iagc proportionally increases the base voltage of transistor T1 232, which allows a proportional increase in current through T1 and away from the path through transistor T2 208 thereby keeping the primary path circuit in the linear zone. The amount of attenuation depends on the ratio between Iref and Iagc, such that Iagc is proportional to the input signal. In addition, it is preferred that the Ibias current be equal to the current through T2 208 plus the attenuation current Iatt. (attenuation). The value of Ibias should increase to keep Igain constant, and Ibias is based on the voltage drop across Rload 220 and the reference voltage. Thus, the voltage drop across Rload 220 is controlled to be the same as the reference voltage Vref and the voltage drop across Rload is kept constant, regardless of the value of the input signal (current).

For a small input signal, there would be a small Iagc. So, very little or none of the input signal will be diverted through transistor T1 232. Thus, at low input signals, this circuit topology does not consume more current or attenuate the input signal. At low input signal levels, the circuit of FIG. 2 functions as the circuit of FIG. 1.

FIG. 3 illustrates an alternative embodiment of the circuit shown in FIG. 2. As compared to FIG. 2, like elements are identified with identical reference numbers. Only the new aspects of FIG. 3, as compared to FIG. 2, are discussed below. In this alternative embodiment, a voltage source, generating a pink voltage on node 308, is used to reverse bias a photodetector 304. The photodetector 304 receives and converts an optic signal into an electrical signal. The output of the photodetector 304 connects to the input node 204 as shown.

In this embodiment, the current Iagc from FIG. 2 is referred to as Imon. The impedance of transistor T1 232 is controlled by the base voltage of T1, which is controlled by the Imon. The bias current for transistor T1 232 is Iatt. In this example configuration, the value of Imon is the current from the photodiode (a current proportion to the photodiode current) divided by 8. This is but one possible example embodiment, and in other embodiments, a different divider value may be used, or none at all. In general, the value of Imon is derived from the input current so that the attenuation path current (auxiliary path current) will vary with the input power.

In this embodiment, the pink voltage is generated by a regulator circuit 324, and as part of this process, the Imon current is generated by tapping or measuring the regulator current, voltage, or both. As shown, regulator 324 generates the pink voltage. The inputs to the regulator 324 include a supply voltage on supply node 330 and a regulator reference voltage Vref on node 344. Associated with the regulator 324 is a sensing circuit 340 that senses the voltage, current, or both provided by the regulator as the pink voltage to the photodiode 304. The sensing circuit can generate Imon directly or provide a control value to a current source 320 that is configured to generate Imon. A divider or multiplier (not shown) may be used to adjust the value of Imon. By having Imon track the power of the input signal, additional current may be directed through the attenuation path (through T1 232) to reduce the current through the main path, which thereby maintains the linearity of the amplifier main path while also not adversely affecting the system operation when the input signal power is low.

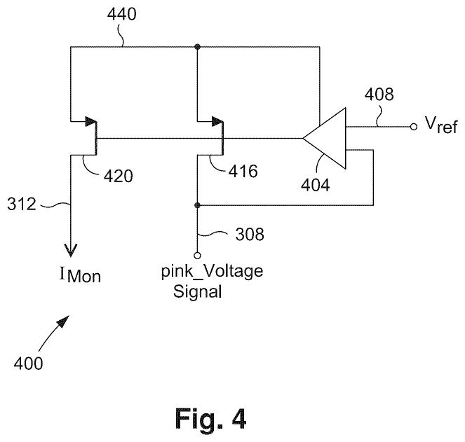

FIG. 4 illustrates an example embodiment of the regulator with a sensing capability. This is but one possible configuration and a such other designs are contemplated. As shown in FIG. 4, the regulator 400 is configured with a comparator 404 that receives a regulator reference voltage Vref 408. The output of the comparator 404 is provided to a gate terminal of a first FET 416. One of the first FET 416 terminals is fed back into the comparator 404 as the comparator's second input, while the other terminal of the first FET is connected to a bias signal to power the comparator through node 440. A second FET 420 also connects to the first FET 416 as shown by connecting the gate terminals. One of the terminals of the second FET provides the Imon signal 312 to the base of T1 232 (FIG. 3). The other terminal of the second FET 420 ties into the node 440. The value of Vref is specified or set by the customer as the bias for the photodetector 304.

Returning to FIG. 3, the embodiment as shown is configured for use with a photodetector in an optic signal system; the same principles may be applied if an antenna is the device creating the electrical version of the received signal instead of the photodetector. In a wired line system, the electrical signal may be presented directly to the input node 204. In addition, a pink voltage or biasing current may not be available in such a system. However, a different parameter may be used to generate the Imon value that controls how much, if any, of the input signal is directed to the attenuation path.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

1. A method to amplify a received signal, which can vary over a power range from a low power to a high power, comprising:
receiving a received signal at a receiver input;
sensing a received signal magnitude;
presenting the received signal to a main amplifier path and an attenuation path, wherein a main path signal portion of the received signal and an attenuation path signal portion of the received signal is determined by the received signal magnitude;
generating a control signal that is proportional to the received signal magnitude; and
responsive to the control signal, adjusting an impedance of the attenuation path such that an increase in signal magnitude results in a reduction in the impedance of the attenuation path and a corresponding increase in the attenuation path signal portion, thereby reducing the main path signal portion, thereby maintaining operation of the amplifier in a linear operating region when receiving high power received signal.

2. The method of claim 1, wherein the received signal is one of the following: an optic signal, a wireless signal and an electrical signal.

3. The method of claim 1, wherein sensing a received signal magnitude is performed by a regulator and a sensing circuit, that includes a comparator and two or more field effect transistors.

4. The method of claim 1, wherein sensing the received signal magnitude comprises sensing a photodetector bias signal.

5. The method of claim 1, wherein adjusting the impedance of the attenuation paths occurs by the control signal changes a voltage presented to a base terminal of a transistor in the attenuation path.

6. The method of claim 1, further comprising, responsive to the received signal being in a bottom 10% of the power range for the received signal, establishing the impedance of the attenuation path high to direct all of the received signal to the main amplifier path.

7. The method of claim 1, further comprising biasing the main amplifier path and the attenuation path with a bias current from a current source, wherein the bias current is proportional to a reference voltage in relation to a voltage across a load resistor.

8. An amplifier, configured to receive and amplify a received signal having a power range that is greater than the amplifier's linear operating region, comprising:
an input configured to receive the signal to be amplified;
a sensing circuit configured to:
sense the power of the received signal directly or through monitoring of another signal to determine an input signal power level; and
responsive to the input signal power level, generate an impedance control value that is proportional to the input signal power level;
a main signal path connected to the input and configured to amplify a main path signal portion to generate an amplified signal; and
an attenuation signal path connected to the input having a variable impedance, the impedance of the variable impedance controlled by the impedance control value, wherein as the input signal power level increases, the impedance control value reduces the variable impedance, thereby diverting a larger portion of the input signal away from the main signal path and through the attenuation signal path, and as the input signal power level decreases, the impedance control value increases the variable impedance thereby diverting a smaller portion of the input signal through the attenuation signal path.

9. The amplifier of claim 8, wherein the signal originated as an optic signal, a wireless signal, or an electrical signal.

10. The amplifier of claim 8, wherein the sensing circuit comprises a regulator that generates a bias signal and a sensing circuit to determine the value of the bias signal.

11. The amplifier of claim 8, wherein the variable impedance comprises an attenuation signal path transistor and the impedance control value sets a base voltage for the attenuation signal path transistor.

12. The amplifier of claim 8, wherein the received signal is an optic signal, the amplifier is a transimpedance amplifier, and a photodetector converts the optic signal to an electrical signal.

13. The amplifier of claim 8, further comprising a bias current source configured to provide a main signal path bias current to the main signal path and an attenuation signal path bias current to the attenuation signal path, wherein the bias current source is controlled by a bias current control signal that is proportional to a reference voltage.

14. An amplifier, configured as part of a receiver to receive and amplify a received signal having a power range that is greater than the amplifier's linear operating region, comprising:
a main signal path comprising an amplifier configured to amplify a received signal or a portion of the received signal;
an attenuation signal path comprising an impedance control device that has an impedance controlled by an impedance control signal such that the impedance of the impedance control device determines how much of the received signal flows through the attenuation signal path; and
an impedance control signal generator configured to generate the impedance control signal based on the power level of the received signal.

15. The amplifier of claim 14, wherein the variable impedance comprises an attenuation signal path transistor and the impedance control value sets a base voltage for the attenuation signal path transistor.

16. The amplifier of claim 14, wherein the amplifier is a transimpedance amplifier, and a photodetector converts an optic signal to the received signal.

17. The amplifier of claim 14, further comprising a bias current source configured to provide a main signal path bias current to the main signal path and an attenuation signal path bias current to the attenuation signal path, wherein the bias current source is controlled by a bias current control signal that is proportional to a reference voltage.

18. The amplifier of claim 14, further comprising a sensing circuit configured to sense the level power of the received signal directly or by monitoring of another signal in the receiver to determine the power level of the received signal.

19. The amplifier of claim 14, wherein as the input signal power level of the received signal increases, the impedance control value reduces the variable impedance, thereby diverting a larger portion of the received signal away from the main signal path and into the attenuation signal path, and as the power level of the received signal decreases, the impedance control value increases the variable impedance thereby diverting a smaller portion of the received signal through the attenuation signal path.

20. The amplifier of claim 14, wherein the impedance control signal is a current that generates a base voltage for an attenuation path transistor.
